(19) United States
(12) Patent Application Publication
(10) Pub. No.: US 2005/0212267 A1
(43) Pub. Date: Sep. 29, 2005

(54) Carrier device

(76) Inventor: Yi-Chuan Hsu, Miaoli City (TW)

Correspondence Address: BRUCE H. TROXELL;SUITE 1404, 5205 LEESBURG PIKE, FALLS CHURCH, VA, 22041, US

(21) Appl. No.: 11/086,332

(22) Filed: Mar. 23, 2005

(30) Foreign Application Priority Data
Mar. 29, 2004 (TW) 93204786
Sep. 20, 2004 (TW) 93215029

(51) Int. Cl. B62B 1/00; B62B 7/02; B62B 9/00

(52) U.S. Cl. 280/655; 280/47.315; 190/18 A

(57) ABSTRACT

A carrier device, on which user can step to drive the carrier device running, has a carrier member with a space therein for storage, a plurality of wheel assemblies pivoted on a bottom thereof to slide the carrier member, a handle member at a side thereof to be held by a user, and a step portion for the user stepping thereon by a foot to drive the carrier member running.

### BACKGROUND OF THE INVENTION

1. Field of the Invention

The present invention relates generally to a device for transportation, and more particularly to a carrier device, on which user steps for moving.

2. Description of the Related Art

Typically, conventional carrier devices, such as luggage and hand cart, have a carrier member, on a side of which a handle is provided. User holds the handle to draw the carrier device moving. It is a hard job to move the carrier device while heavier goods are stored in the carrier member.

An improved carrier device is provided with a step on the carrier member, on which the user steps for moving. The step and the associated elements, which connect the step on the carrier member, cost too much, so that such carrier device is expensive.

In addition, some of the conventional luggages are provided with a foldable or retractable carrier frame on a bottom thereof to carry more goods. Except for the carrier frame, the luggage has two or more universal wheels on the bottom also. Such luggage is easy to tip over when user draws it for turn, so that the luggage still has to be improved.

### SUMMARY OF THE INVENTION

The primary objective of the present invention is to provide a carrier device having none of the drawbacks of the conventional device.

The secondary objective of the present invention is to provide a carrier device, which the carrier member can be increased the storage space thereof but still keep the balance for moving.

According to the objectives of the present invention, a carrier member comprises a carrier member with a space therein for storage, wheel assemblies pivoted on a bottom thereof to slide the carrier member, a handle member at a side thereof to be held by a user, and a step portion for the user stepping thereon by a foot to drive the carrier member running.

### BRIEF DESCRIPTION OF THE DRAWINGS

FIG. 1 is a perspective view of a first preferred embodiment of the present invention;

FIG. 2 is a bottom view of the first preferred embodiment of the present invention, showing a person stepping on the step portion;

FIG. 3 is a perspective view of a second preferred embodiment of the present invention;

FIG. 4 is a perspective view of a third preferred embodiment of the present invention;

FIG. 5 is a perspective view of a fourth preferred embodiment of the present invention;

FIG. 6 is a rear view of the fourth preferred embodiment of the present invention, showing the turning apparatus;

FIG. 7 is a front view of a fifth preferred embodiment of the present invention;

FIG. 8 is a left view of the fifth preferred embodiment of the present invention;

FIG. 9 is a perspective view of a sixth preferred embodiment of the present invention;

FIG. 10 is a perspective view of a seventh preferred embodiment of the present invention;

FIG. 11 is a perspective view of an eighth preferred embodiment of the present invention;

FIG. 12 is a left view of a ninth preferred embodiment of the present invention;

FIG. 13 is a front view of the ninth preferred embodiment of the present invention;

FIG. 14 is a bottom view of the ninth preferred embodiment of the present invention, showing the movable base, the balance apparatus and the turning apparatus;

FIG. 15 is a left view of a part of the ninth preferred embodiment of the present invention, showing the movable base, the balance apparatus and the turning apparatus;

FIG. 16 is a front view of a tenth preferred embodiment of the present invention;

FIG. 17 is a left view of a part of the tenth preferred embodiment of the present invention, showing the moving apparatus shifting the carrier member;

FIG. 18 is a left view of the tenth preferred embodiment of the present invention in operation;

FIG. 19 is a front view of an eleventh preferred embodiment of the present invention;

FIG. 20 is a front view of the eleventh preferred embodiment of the present invention, showing the moving apparatus opening the bottom of the carrier;

FIG. 21 is a left view of a twelfth preferred embodiment of the present invention, and

FIG. 22 is a front view of the twelfth preferred embodiment of the present invention.

### DETAILED DESCRIPTION OF THE INVENTION

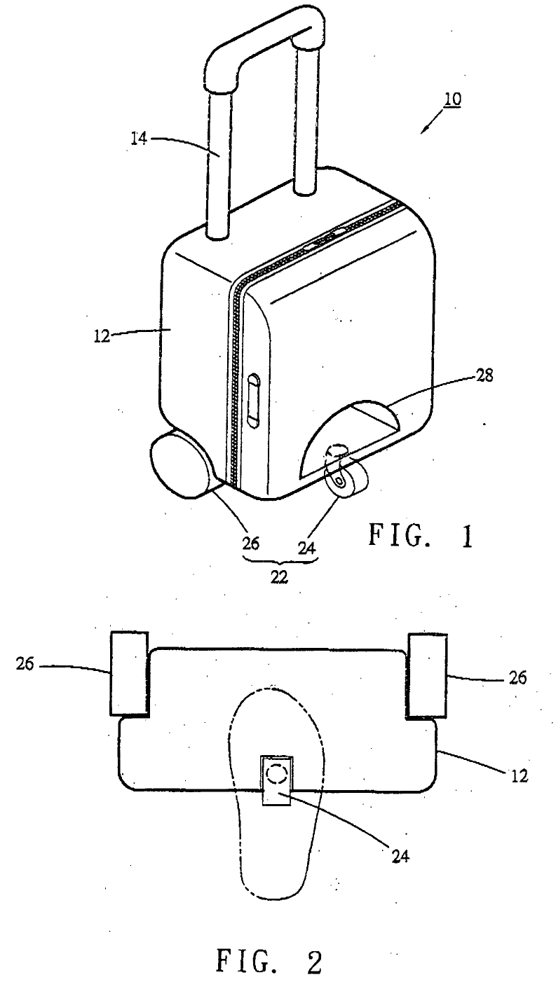

As shown in FIG. 1 and FIG. 2, a carrier device 10 of the first preferred embodiment of the present invention comprises a carrier member 12 and a handle member 14.

The carrier member 12 is a case with a space therein to store goods. The carrier member 12 has a wheel assembly 22 at a bottom thereof. The wheel assembly 22 includes a turning wheel 24 and two wheels 26. The carrier member 12 further has a step portion 28 at a side opposite to the handle member 14 and adjacent to the bottom thereof. The step portion 28 is a cavity for foot stepping.

The handle member 14 is provided on the carrier member 12 for user holding to draw the carrier member 12 moving or to lift it.

To use the carrier device 10 of the present invention, user can hold the handle member 14 to draw the carrier member 12 moving or user can have a foot stepping on the step portion 28 to move the carrier device 10 like the skateboard.

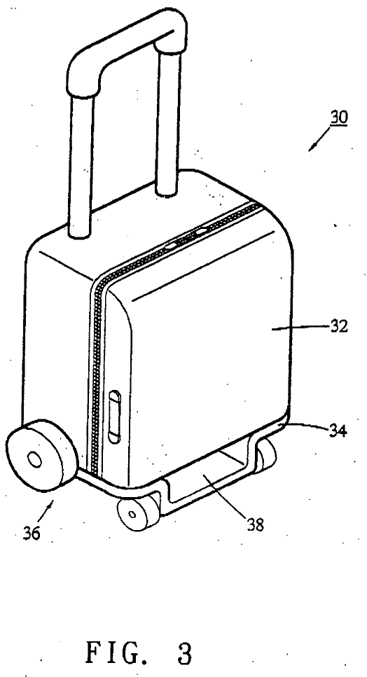

As shown in FIG. 3, a carrier device 30 of the second preferred embodiment of the present invention is further provided with a movable base 34 on a bottom of a carrier member 32 thereof. The movable base 34 is made of a rigid material with a wheel assembly 36 pivoted thereon. A step portion 38 is a space between the carrier member 32 and the movable base 34 with an opening at a front side of the carrier device 30. The movable member 34 is detachably fixed to the carrier member by bolts or by slots and tenons on the carrier member 32 and the movable base 34 respectively.

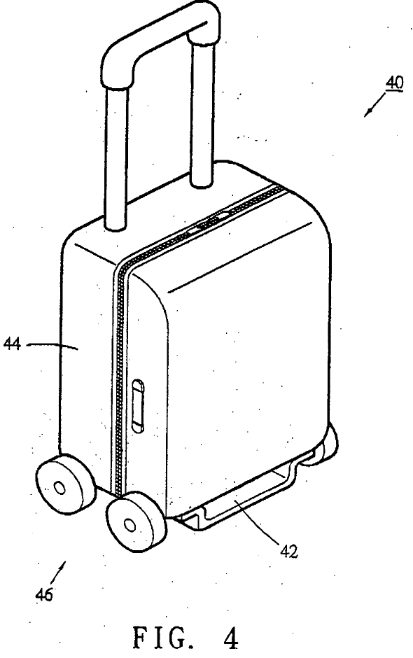

FIG. 4 shows a carrier device 40 of the third preferred embodiment, which a movable base 42 is fixed on a bottom of a carrier member 44 and a wheel assembly 46 is pivoted on the carrier member 44 rather than on the movable base 42.

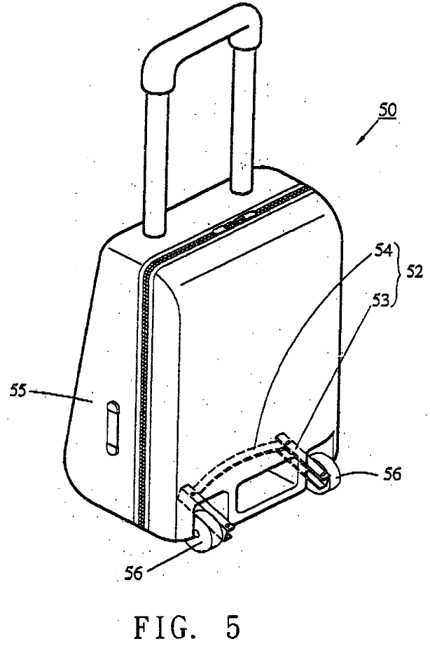

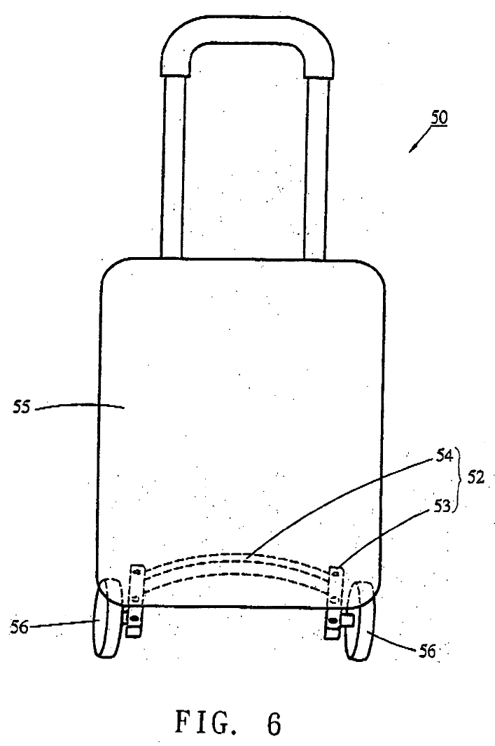

FIG. 5 and FIG. 6 show a carrier device 50 of the fourth preferred embodiment, which is similar to the carrier device 10 of the first preferred embodiment, except that the carrier device 50 further has a turning apparatus 52. The turning apparatus 52 includes two turning members 53 and a linkage 54, in which the turning members 53 have an inner end pivoted on a bottom of a carrier member 55 and an outer end pivoted with a turning wheel 56 respectively, and the linkage has opposite ends pivoted on the turning members 53 respectively. The turning apparatus 52 makes it easier and smoother to turn the carrier device 50.

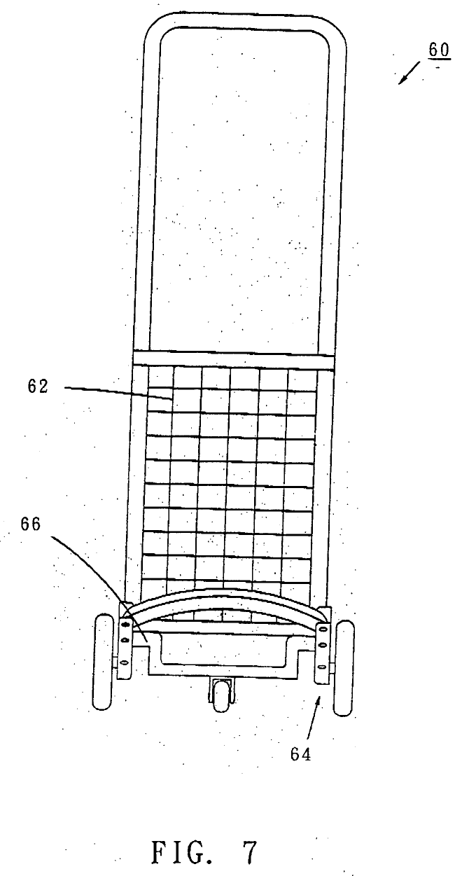

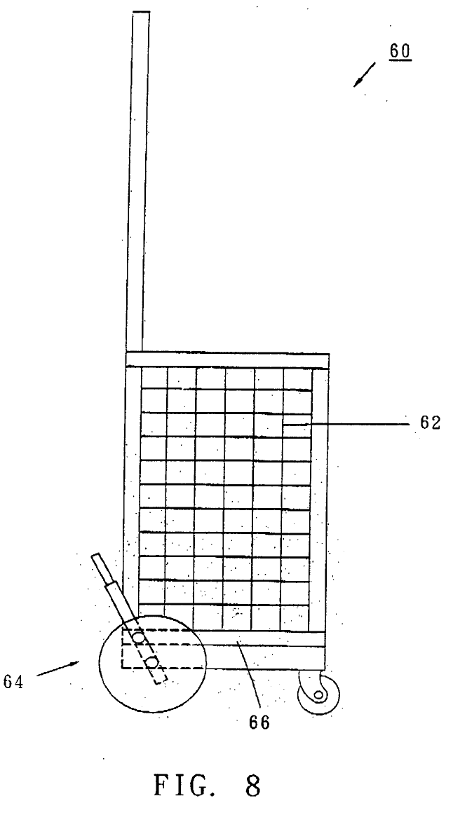

FIG. 7 and FIG. 8 show a carrier device 60 of the fifth preferred embodiment of the present invention, which a carrier member 62 is a conventional hand cart and a turning apparatus 64 is provided at a movable base 66 on a bottom of the carrier member 62.

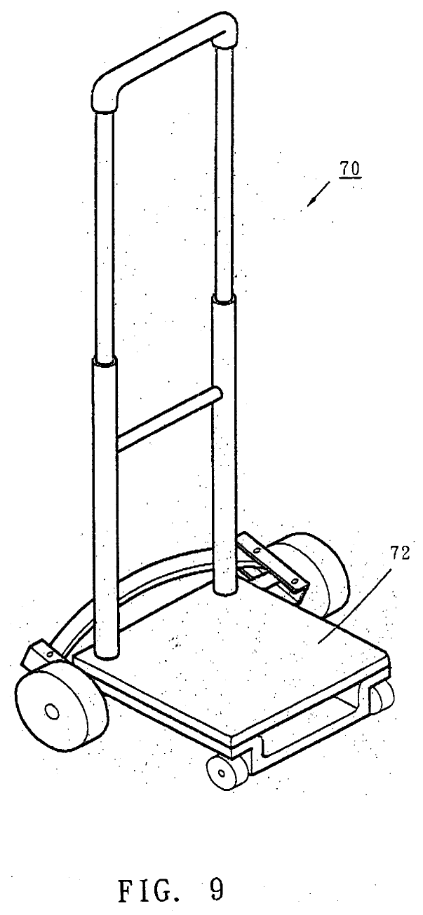

A carrier device of the sixth preferred embodiment of the present invention, as shown in FIG. 9, has a carrier member 72 with a platform.

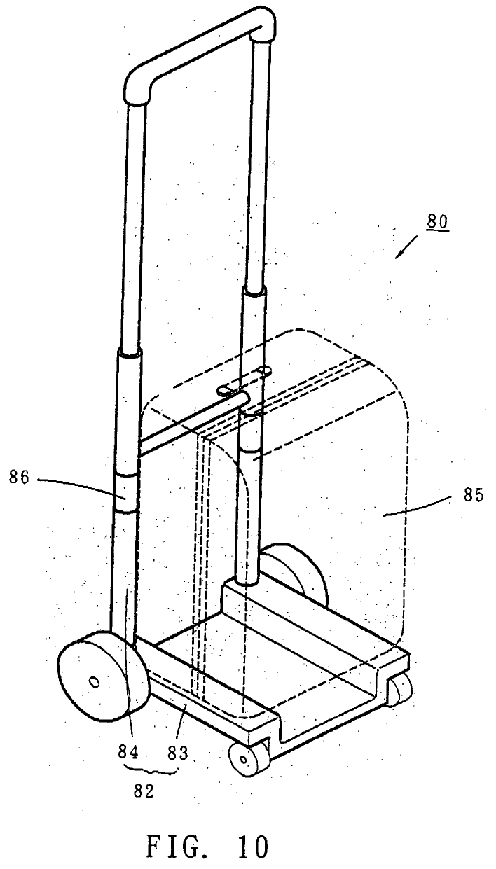

FIG. 10 shows a carrier device 80 of the seventh preferred embodiment of the present invention, which a movable base 82 includes a base 83 and a supporting member 84 on a top of the base 83. A carrier member 85 is rested on the base 83 and against the supporting member 84. The supporting member 84 is provided with a fastener 86 to fix the carrier member 85. In the present embodiment, the fastener 86 is a Velcro belt.

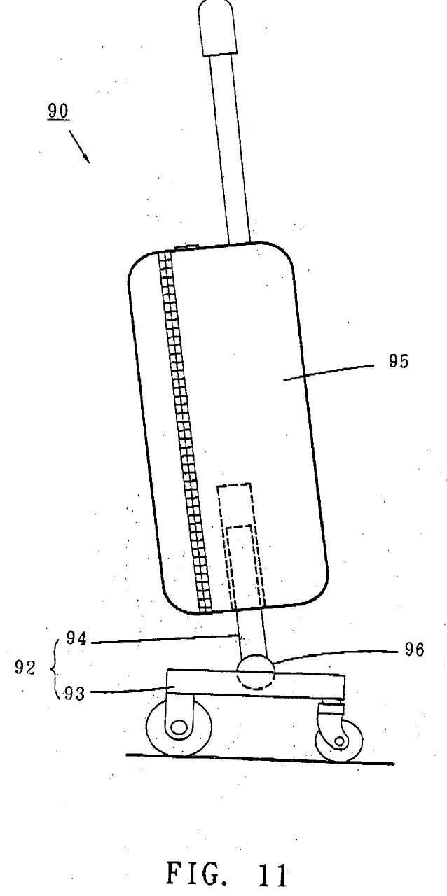

FIG. 11 shows a carrier device 90 of the eighth preferred embodiment of the present invention, which a movable base 92 includes a base 93 and a supporting member 94 pivoted on a top of the base 93. A carrier member 95 is mated with the supporting member 94. The supporting member 94 may be a conventional universal joint pivoted on the base 93. The supporting member 94 is retractable to rest the carrier member 95 on the base 93 or to lift the carrier member 95 from the base 93 or to turn the carrier member 95 to a predetermined angle relative to the base 93, such that a space, so called the step portion, is formed between the base 93 and the barrier member 95 for user stepping on the base 93 by a foot.

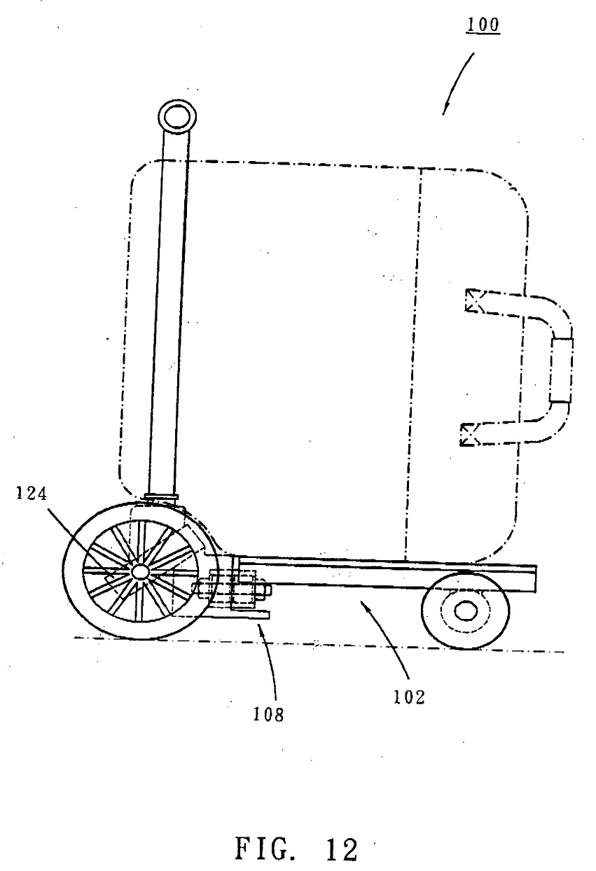

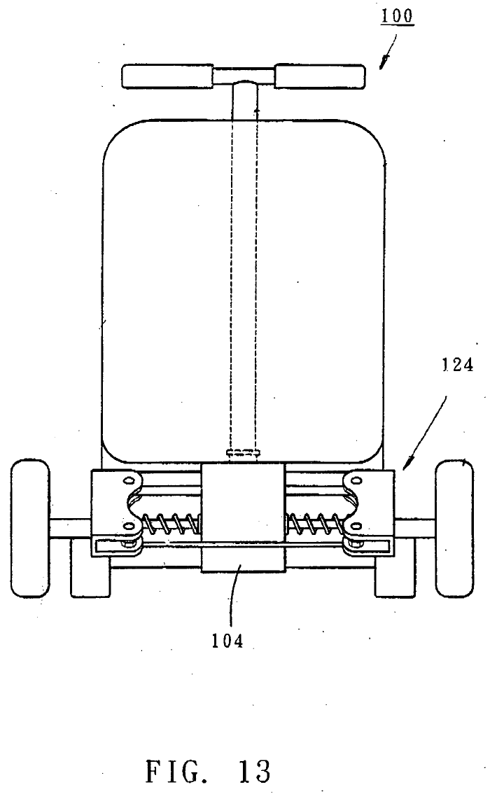

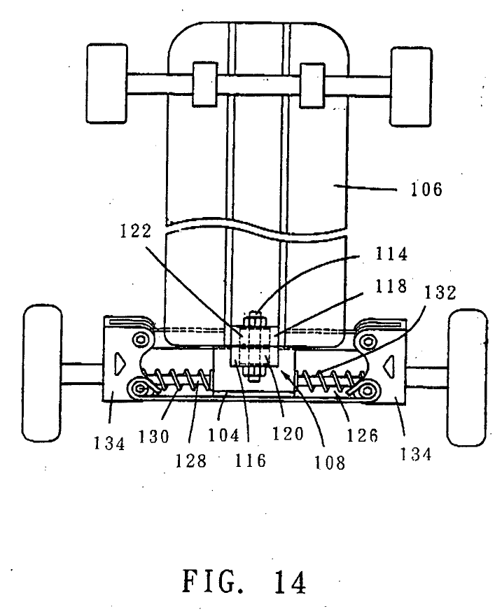

As shown in FIGS. 12 to 15, a carrier device 100 of the eighth preferred embodiment of the present invention, which is similar to the above embodiments, has a movable base 100 with a base 104 and a carrier 106. A balance apparatus 108 is provided to pivot the carrier 106 on a rear end of the base 104, which has a first linkage assembly 110, a second linkage assembly 112 and a shaft 114. The first and second linkage assemblies 110 and 112 are provided at the rear end of the base 104 and at a front end of the carrier 106 respectively, which have a hollow base member 116, 118 and a bearing 120, 122 in the hollow base member 116, 118 respectively. Two ends of the shaft 114 are fitted to the bearings 120, 122 respectively for rotation the carrier 106 relative to the base 104. The carrier device 100 further has a turning apparatus 124, which has a return assembly 126 including a movable shaft 128 pivoted between two turning member 134 and passing through a bottom of the base 104 for movement. Two elastic members 130, 132 are fitted to the movable shaft 128 between the bottom of the base 104 and the turning members 134 respectively.

While a user draws the carrier device 100 and makes a turn, the turning apparatus 124 turns along with the drawing direction of the user to turn the wheels simultaneously, such that there is no such condition of one of the wheel suspended. While the turning apparatus drives the base 104 tilted, the balance apparatus 108 keeps the carrier 106 still from tilting with the base 104. The turning apparatus 124 and the balance apparatus 108 are provided to facilitate user drawing the carrier device 100 and making a turn. The wheels of the carrier device 100 keeps attachment on the ground when turn. User exerts less force on the carrier device 100 of the present invention when makes a turn and the carrier device 100 will not tip over in the turn.

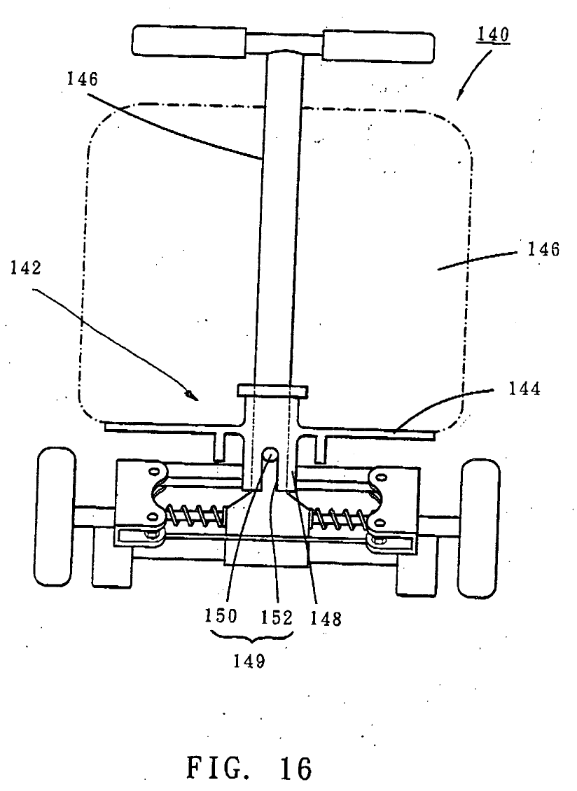

FIG. 16 and FIG. 17 show a carrier device 140 of the tenth preferred embodiment of the present invention, which further comprises a moving apparatus 142. The moving apparatus 142 includes a carrier plate 144, on which a carrier member 146 is rested. A tube-like pivot block 148 is fixed to an end of the carrier plate 144 and fitted to a handle member 146. A positioning assembly 149 has two pins 150 inserted into the handle member 146 via opposite sides respectively. The pivot block 148 is provided with two parallel slots 152 at a bottom thereof. The pins 150 are adapted to be inserted into the slots 152 to fix the carrier plate 144 on a base 154. An angle between the pins 150 is 180 degrees, and the angle between the pins may be any degrees.

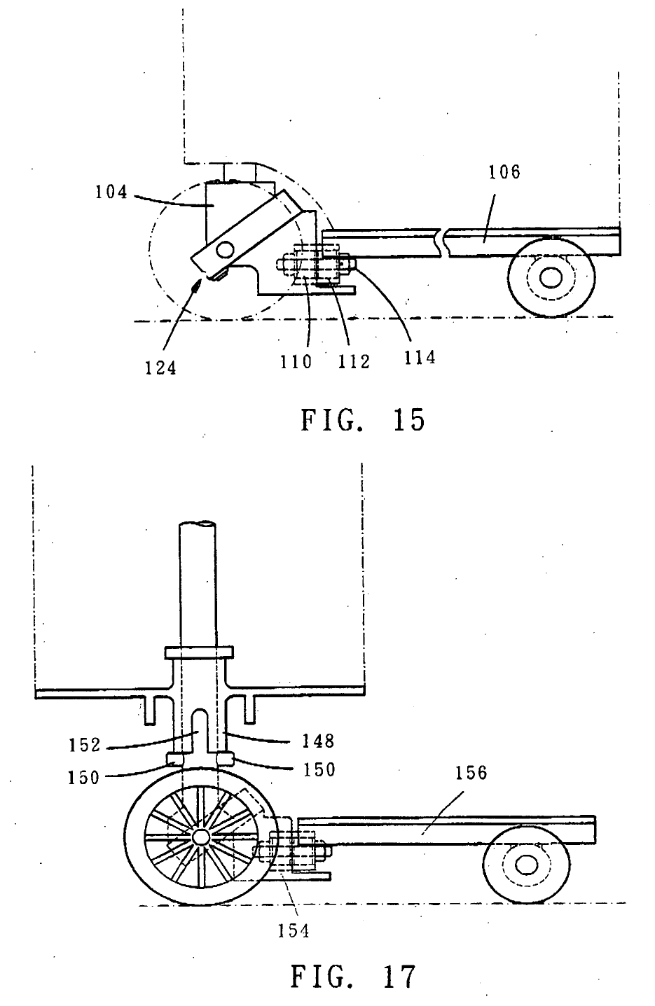

The carrier device 140 can be drawn by user easily and smoothly. Except that, the carrier 146 member may be lifted, and the positioning assembly 148 is released to rotate the carrier member 146 to a front side of the base 154. And then, the carrier member 146 is lowered to insert different pins into the slots 152 for fix of the carrier member 146 in a new position, as shown in FIG. 18. As a result, there is a space above the base 154 and carrier 156 for storage of goods, which could not be stored in the carrier member 146, such as shoes flowerpot.

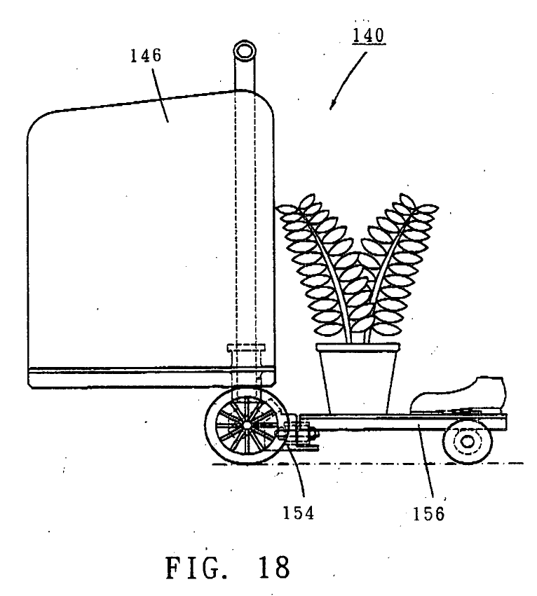

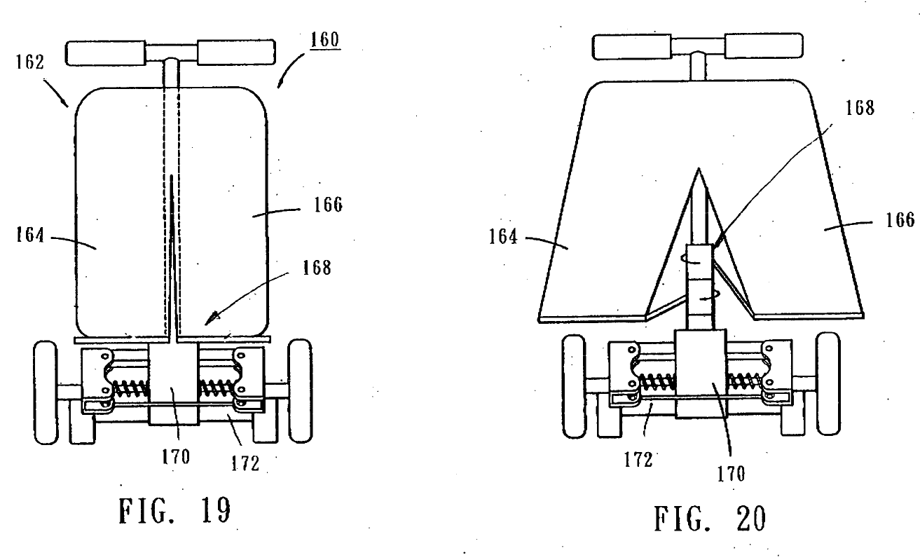

FIG. 19 and FIG. 20 show a carrier device 160 of the eleventh preferred embodiment of the present invention, in which a carrier member 162 has a left case member 164 and a right case member 166. The left and right case members 164 and 166 are in connection at tops thereof and are in separation at bottoms thereof. A moving apparatus 168 connects the bottoms of the left and right case members 164 and 166. The carrier member may have two independent left and right case members also.

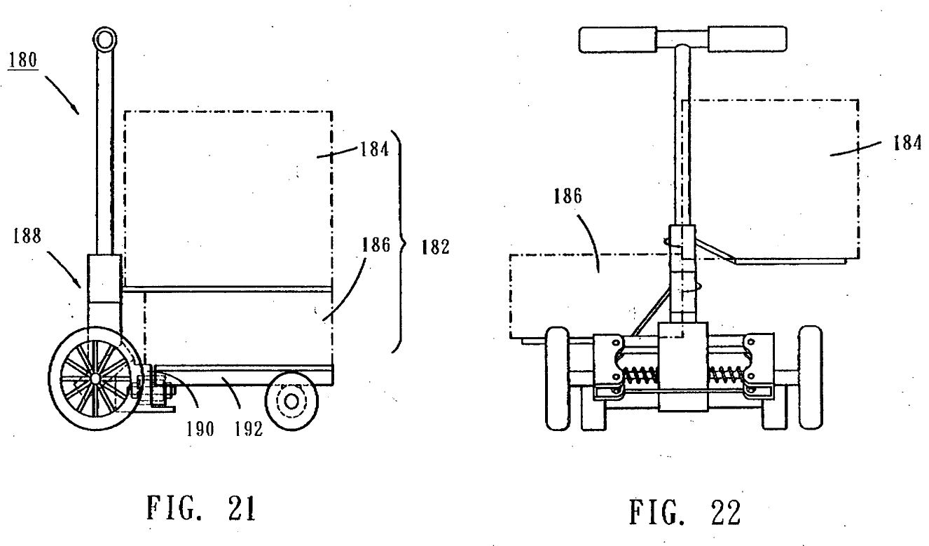

FIG. 20 and FIG. 21 show a carrier device 180 of the twelfth preferred embodiment of the present invention, in which a carrier member 182 has an upper case member 184 and a lower case member 186. A moving apparatus 188 is adapted to rotate the upper and lower case members 184 and 186 in opposite orientations respectively. The upper and lower case members 184 and 186 are moved out of a base 190 to have a space above the base 190 and a carrier 992 for storage of more goods.

1. A carrier member, comprising: a carrier member with a space therein for storage, wheel assemblies pivoted on a bottom thereof to slide the carrier member, a handle member at a side thereof to be held by a user, and a step portion for the user stepping thereon by a foot to drive the carrier member running.

2. The carrier member as defined in claim 1, wherein the step portion is provided at a side of the carrier member adjacent to the bottom thereof.

3. The carrier member as defined in claim 1, further comprising movable base, on a top of which the carrier member is provided and on a bottom of which the wheel assemblies are provided.

4. The carrier member as defined in claim 2, wherein the step portion is a cavity on the carrier member.

5. The carrier member as defined in claim 1, further comprising a turning apparatus provided on the bottom of the carrier member to connect at least a wheel of the wheel assembly and the handle assembly, whereby the wheel is turned by turning the handle member.

6. The carrier member as defined in claim 5, wherein the turning apparatus has a linkage and two turning members pivoted on opposite ends of the linkage respectively and each of the turning members is pivoted with a wheel of the wheel assembly.

7. The carrier member as defined in claim 1, wherein the carrier member is a case.

8. The carrier member as defined in claim 1, wherein the carrier member is a basket.

9. The carrier member as defined in claim 1, wherein the wheel assembly has at least a turning wheel and wheel.

10. The carrier member as defined in claim 3, wherein the movable base has a base, a supporting member provided on the base and the carrier member is rested on the base and connected to the supporting member.

11. The carrier member as defined in claim 10, wherein the supporting member is pivoted on the base.

12. The carrier member as defined in claim 3, further comprising a carrier connected to the movable base and a balance apparatus connecting the movable base and the carrier to provide the carrier a stable condition and the wheel assembly attached on ground while the carrier member makes a turn.

13. The carrier member as defined in claim 12, wherein the balance apparatus has a first linkage assembly provided at an end of the movable base, a second linkage assembly provided at the carrier associated with the first linkage assembly and a shaft pivotally connecting the first linkage assembly and the second linkage assembly.

14. The carrier member as defined in claim 13, wherein the first linkage assembly has a hollow base member in which a bearing is provided to connect the shaft.

15. The carrier member as defined in claim 6, wherein the turning apparatus further has a return assembly to move the turning members back to their initial positions automatically.

16. The carrier member as defined in claim 6, further comprising a moving apparatus provided on the movable base to connect the carrier member, so that the carrier is adapted to be fixed on the movable base and to be moved beyond the movable base.

17. The carrier member as defined in claim 16, wherein the handle member is a center of rotation of the moving member to move the carrier member.

18. The carrier member as defined in claim 16, wherein carrier member has a left case and a right case, and the moving apparatus connects the left case and the right case at bottoms thereof, such that the moving apparatus moves the left case and the right case distal to each other to have a space above the base.

19. The carrier member as defined in claim 16, wherein the moving apparatus has a carrier plate, a pivot block provided at an end of the carrier plate and pivoted on the handle member and a positioning assembly adapted to fix the pivot block to the handle member at predetermined positions respectively.

20. The carrier member as defined in claim 19, wherein the positioning assembly further has pins, each of which is provided to a bottom of the handle member with a predetermined interval therebetween, and the pivot block is provided with slots to be mated with the pins respectively.
